(19) United States
(12) Patent Application Publication
(10) Pub. No.: US 2003/0130801 A1
(43) Pub. Date: Jul. 10, 2003

(54) Viral genomics quality assurance method and apparatus

(76) Inventor: Ron M. Kagan, Mission Viejo, CA (US)

Correspondence Address: Pillsbury Winthrop LLP, Intellectual Property Group, Suite 200, 11682 El Camino Real, San Diego, CA, 92130, US

(21) Appl. No.: 10/042,774

(22) Filed: Jan. 8, 2002

(51) Int. Cl. G06F 7/00

(52) U.S. Cl. 702/20

(57) ABSTRACT

A control method, apparatus, and system to actively assure the quality of a biological sample through genetic or nucleic acid sequence screening. The genetic information from the biological sample is sequenced and associated with patient information, such as patient name or other patient identifier. The genetic sequence is then compared with other entries in a sequence database to determine the closest matches within the database, and further compared with a confidence threshold. A report may then be generated indicating whether the closest matches within the confidence threshold match the patient information. The quality assurance integrity of the biological sample can be determined when the patient information of the biological sample matches previous samples from the same patient.

### BACKGROUND

1. Field of the Invention

Aspects of the present invention relate in general to a method, apparatus and system to actively assure the quality of a biological sample through genetic or nucleic acid sequence screening, i.e. “genetic fingerprinting.”

2. Description of the Related Art

Conventionally, it is difficult to determine whether a patient's biological sample has been contaminated or accidentally switched. Improperly cleaned sample containers, contamination by spillage from other samples, and mistaken labeling of samples all contribute to faulty biological test results.

### BRIEF DESCRIPTION OF THE DRAWINGS

FIG. 1 illustrates an embodiment of a system to actively assure the quality of a biological sample through genetic or nucleic acid sequence screening.

FIG. 2 is a block diagram of an embodiment of an apparatus to actively assure the quality of a biological sample through genetic or nucleic acid sequence screening.

FIG. 3 is an expanded block diagram of an apparatus to actively assure the quality of a biological sample through genetic or nucleic acid sequence screening.

FIG. 4 is a flowchart of a method to actively assure the quality of a biological sample through genetic or nucleic acid sequence screening.

FIG. 5 is a flowchart of a method to determine a confidence threshold to assure the quality of a biological sample through genetic or nucleic acid sequence screening.

FIG. 6 is a histogram of normalized scores of sequence searches, used to determine a confidence threshold to assure the quality of a biological sample through genetic or nucleic acid sequence screening.

FIG. 7 depicts an embodiment of an example output from a system to assure the quality of a biological sample through genetic or nucleic acid sequence screening.

### DETAILED DESCRIPTION

What is needed is an easy-to-use system, apparatus and method to assure the quality of a biological sample through genetic or nucleic acid sequence screening.

Aspects of the present invention include a system, method and apparatus that assures the quality of a biological sample through genetic or nucleic acid sequence screening.

One aspect of the invention includes the discovery and realization that the concept of genetic fingerprinting may be used to assure the sample quality of a biological specimen.

Another aspect of the invention includes the discovery that the quality assurance of a biological sample may be genetically fingerprinted not only by the genetic code of the person submitting the sample, but also by the genetic sequence of a virus. This can be accomplished even though the virus is constantly mutating:

In one embodiment, a virus or other genetic or nucleic acid sequence is sequenced from a biological sample specimen. The sequence is then compared to previously sequenced profiles stored in a sequence database. Each of the closest matches to the sequence are normalized or scored to determine their closeness. If a match score fall within a confidence threshold, the patient name attached to the sample specimen sequence is compared to the names of the database matches. If the names match, the sample source is assured.

Embodiments of the invention include, but are not limited to, generic computing and communications devices that perform an embodied method, a standalone computing device that matches a specimen sequence with profiles stored in a database, and a system that receives a sample sequence listing for quality assurance testing.

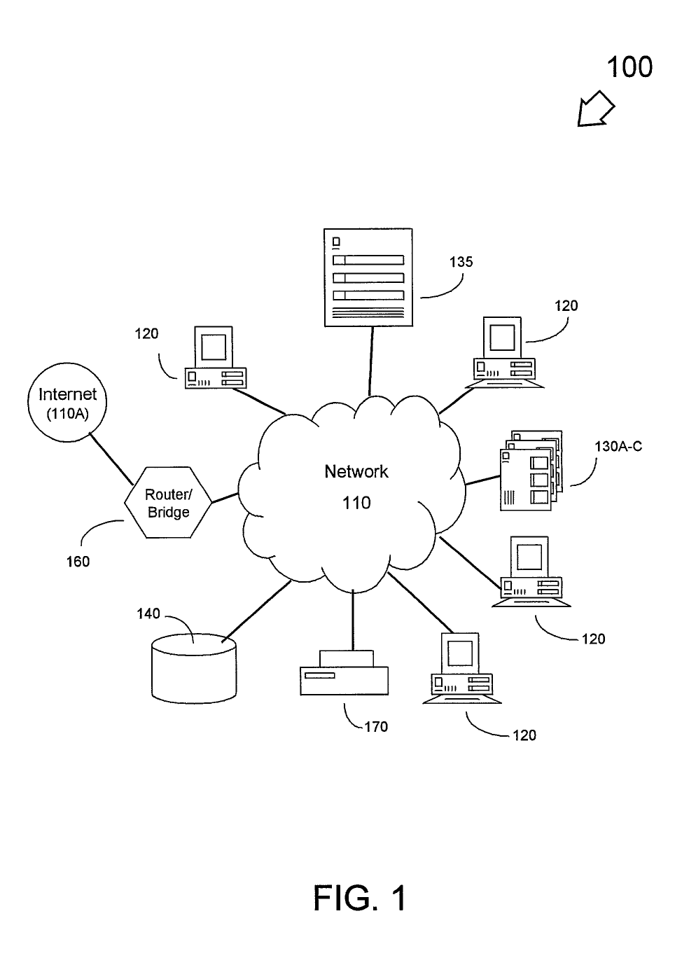

FIG. 1 is a simplified functional act diagram depicting system 100, constructed and operative in accordance with an embodiment of the present invention. System 100 is configured to assure the quality of a biological sample through genetic or nucleic acid sequence screening.

An embodiment of the method receives a biological sample containing genomic information. Genomic information may include any nucleic acid sequence. Examples of such sequences include, but are not limited to, viruses, deoxyribonucleic acid (DNA), and ribonucleic acid (RNA). In some embodiments the genomic information may be sequences of Hepatitis B, Hepatitis C, or Human Immunodeficiency Virus (HIV) strains.

In system 100, labs containing remote computers 120 are coupled via a communications network 110. The remote computers 120 or instrumentation co-located near the remote computers 120 may sequence the genomic information contained within the biological sample. Once sequenced, the remote computer 120 forwards the sequence information to quality assurance server 135, which executes a quality assurance method embodiment.

Quality assurance server 135 may be coupled to remote computer 120 via network 110. It is understood by those skilled in the art, that either the remote computers 120 or quality assurance server 135 may be coupled via a single or multiple number of networks without inventive faculty. Furthermore, the number of computers 120 and quality assurance servers 135 may vary from system to system.

In some embodiments, quality assurance server 135 may be a mainframe, mini-computer, computer workstation, personal computer, personal digital assistant (PDA), or other computing device adapted to perform the embodied method.

The network 110 may also include other networkable devices known in the art, such as computers 120, storage media 140, other quality assurance servers 135, servers 130, printers 170, and network devices 160 such as routers or bridges 160. It is well understood in the art, that any number or variety of computer networkable devices or components may be coupled to the network 110 without inventive faculty. Examples of other devices include, but are not limited to, servers, computers, workstations, terminals, input devices, output devices, printers, plotters, routers, bridges, cameras, sensors, or any other such device known in the art.

In one embodiment, quality assurance server 135 may also function as a genomic data-sequencing device, or act as a “plug-in” module for a monitoring device. In such embodiments, quality assurance server 135 may be any apparatus known in the art that are provide quality assurance through comparing the genomic data sequence with other stored sequences.

Network 110 may be any communication network known in the art, including the Internet, a local-area-network (LAN), a wide-area-network (WAN), virtual private network (VPN) or any system that links a computer to an quality assurance server 135. Further, network 110 may be configured in accordance with any topology known in the art, including star, ring, bus, or any combination thereof.

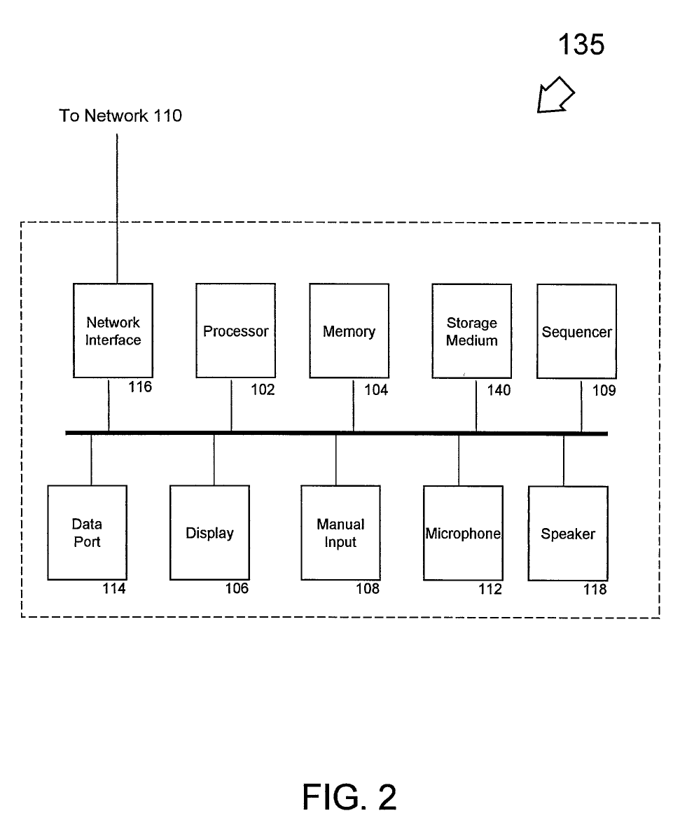

Embodiments will now be disclosed with reference to a block diagram of an exemplary quality assurance server 135 of FIG. 2, constructed and operative in accordance with an embodiment of the present invention. In such an embodiment, quality assurance server 135 runs a multi-tasking operating system and includes at least one processor or central processing unit (CPU) 102. Processor 102 may be any microprocessor or micro-controller as is known in the art.

The software for programming the processor 102 may be found at a computer-readable storage medium 140 or, alternatively, from another location across network 110 through network interface 116. Processor 102 is coupled to computer memory 104. Quality assurance server 135 may be controlled by an operating system (OS) that is executed within computer memory 104.

Processor 102 communicates with a plurality of peripheral equipment, including network interface 116, and data port 114. Additional peripheral equipment may include a display 106, manual input device 108, sequencer 109, storage medium 140, microphone 112, and speaker 118.

Computer memory 104 is any computer-readable memory known in the art. This definition encompasses, but is not limited to: Read Only Memory (ROM), Random Access Memory (RAM), flash memory, Erasable-Programmable Read Only Memory (EPROM), non-volatile random access memory, memory-stick, magnetic disk drive, transistor-based memory or other computer-readable memory devices as is known in the art for storing and retrieving data.

Storage medium 140 may be a conventional read/write memory such as a magnetic disk drive, magneto-optical drive, optical drive, floppy disk drive, compact-disk read-only-memory (CD-ROM) drive, digital video disk read-only-memory (DVD-ROM), digital video disk random-access-memory (DVD-RAM), transistor-based memory or other computer-readable memory device as is known in the art for storing and retrieving data. Storage medium 140 may be remotely located from processor 102, and be coupled to processor 102 via a network 110 such as a local area network (LAN), a wide area network (WAN), or the Internet via network interface 116.

Display 106 may be a visual display such as a cathode ray tube (CRT) monitor, a liquid crystal display (LCD) screen, light emitting diode (LED), touch-sensitive screen, or other monitors as are known in the art for visually displaying images and text to a user.

Manual input devices 108 may be a conventional keyboard, keypad, mouse, trackball, or other input devices as are known in the art for the manual input of data.

Microphone 112 may be any suitable microphone as is known in the art for providing audio signals to processor 102. In addition, a speaker 118 may be attached for reproducing audio signals from processor 102. It is understood that microphone 112, and speaker 118 may include appropriate digital-to-analog and analog-to-digital conversion circuitry as appropriate.

Data port 114 may be any data port as is known in the art for interfacing with an external accessory using a data protocol such as RS-232, Universal Serial Bus (USB), or Institute of Electrical and Electronics Engineers (IEEE) Standard No. 1394 (‘Firewire’). In some embodiments, data port 114 may communicate to external accessories using any interface as known in the art for communicating or transferring files across a computer network. Examples of such networks include Transmission Control Protocol/Internet Protocol (TCP/IP), Ethernet, Fiber Distributed Data Interface (FDDI), ARCNET, token bus, or token ring networks.

In yet other embodiments, quality assurance server 135 may also comprise sequencer 109. Sequencer 109 may be any device known in the art capable of sequencing genetic information from a biological sample. Examples of sequencer 109 include an ABI 310 sequencer, ABI 377 sequencer, ABI 3100 sequencer, ABI 3700 sequencer, Amersham Biosciences MegaBace 1000, or equivalent, which allows the processing, analysis, and assembly into a single consensus sequence for each clinical sample.

Network interface 116 is any interface as known in the art for communicating or transferring files across a computer network. Examples of such networks include TCP/IP, Ethernet, FDDI, ARCNET, token bus, or token ring networks.

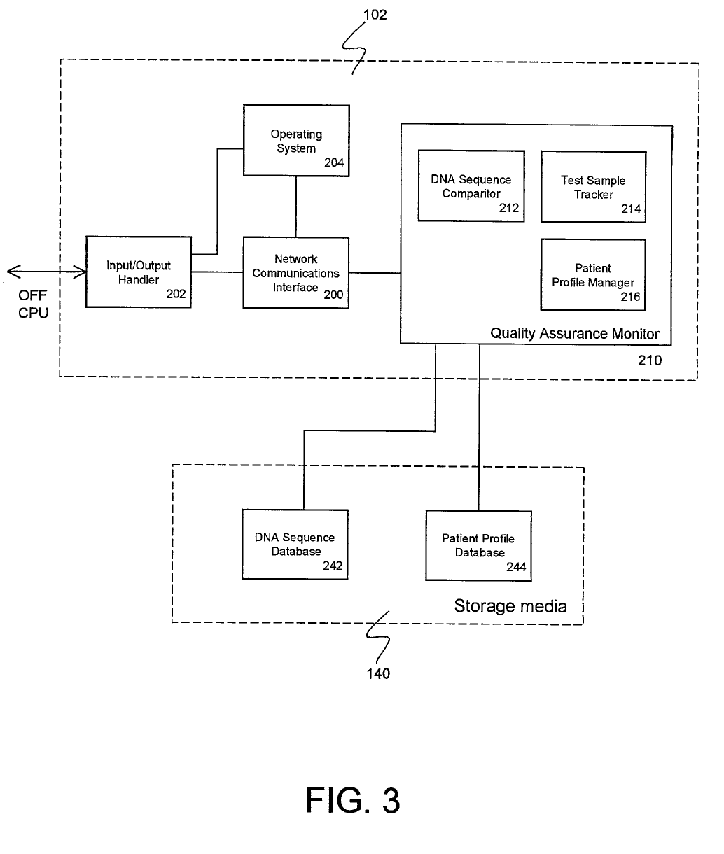

FIG. 3 is an expanded functional act diagram of processor 102 and storage medium 140, constructed and operative in accordance with an embodiment of the present invention. It is well understood by those in the art, that the functional act elements of FIG. 3 may be implemented in hardware, firmware, or as software instructions and data encoded on a computer-readable storage medium 140. Furthermore, it is understood that these structures may be implemented in conjunction with the embodiments described in FIGS. 1-2 above, or separately on their own. As shown in FIG. 3, central processing unit 102 comprises an input/output handler 202, an operating system 204, a network communications interface 200, and a quality assurance monitor 210. In addition, as shown in FIG. 3, storage media 140 may also contain a DNA sequence database 242 and a patient profile database 244.

Input/output handler 202 interfaces devices off the processor 102. In some embodiments, these devices include display 106, manual input device 108, sequencer 109, storage medium 140, speaker 118, microphone 112, input/output port 114, and network interface 116. The input/output handler 202 enables processor 102 to locate data on, read data from, and write data to, these components.

Operating system 204 enables processor 102 to take some action with respect to a separate software application or entity. For example, operating system 204 may take the form of a windowing user interface, as is commonly known in the art.

Network communications interface 200 is a user interface control program. In some embodiments, the network communications interface 200 may be stand-alone user interface program enabling the use of manual input buttons 108, or a graphical-user-interface window.

Quality assurance monitor 210 may further comprise a DNA sequence comparitor 212, a test sample tracker 214, and a patient profile manager 216.

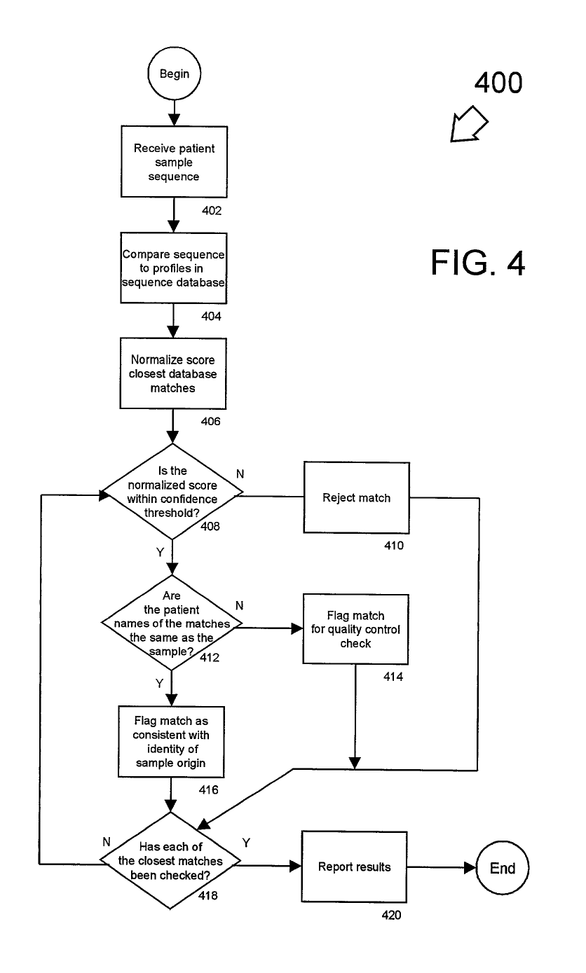

These components of quality assurance monitor 210 interact with a DNA sequence database 242 and patient profile database 244, and may best be understood with respect to flowchart FIG. 4, as described below.

FIG. 4 flowcharts a process 400 to facilitate the quality assurance of a biological sample through genetic or nucleic acid sequence screening, constructed and operative in accordance with an embodiment of the present invention.

At block 402, process 400 receives patient genomic sequence information from a patient sample. In some embodiments, the patient sequence information may be received from sequencer 109. In other embodiments, the patient sequence information may be provided over network 110 by remote computer 120. Regardless, the sequence information may be provided in any format known in the art. Example formats include, but are not limited to, FASTA, Stanford/IG, Human Genome Mapping Project (HGMP) and GenBank formats.

Once received, DNA sequence comparitor 212 compares the patient sequence information with sequences stored in DNA sequence database 242, block 404.

DNA sequence comparitor 212 may be any structure known in the art capable of comparing sequence information. In some embodiments, the DNA sequence comparitor 212 may be the Basic Local Alignment Search Tool (BLAST) program (including variants such as the NCBI Blast program and the WU-BLAST programs), BLocks IMProved Searcher (BLIMPS), or FASTA programs.

An arbitrary number of closest hit scores, as determined by DNA sequence comparitor 212, are normalized, block 406. The normalized scores may be determined simply by the following calculation:

$$NormalizedScore = \frac{selfScore - hitScore}{selfScore}$$

where selfScore is the total number of nucleotide positions of the patient sequence, and hitScore is the number of matching nucleotide positions.

The normalized scores are then compared to a predetermined confidence threshold at block 408. As is discussed below, the confidence threshold is a limit on a range of acceptable matching scores, to insure that a patient's sequence scores match previous their own previous sample sequences while attempting to minimize false negatives. Thus, an ideal confidence threshold is loose enough to insures that previous samples are matched, but restrictive enough to keep out false matches. The confidence threshold may vary from application to application, depending upon the number of nucleotide positions being measured and the type of nucleic acid being sequenced. For example, the confidence threshold for HIV-1 and hepatitis virus sequences may differ. A method embodiment of determining a confidence threshold is discussed below. For illustrative purposes only, the examples below assume a confidence threshold score that is three standard deviations from a mean normalized score.

If the normalized score is not within the confidence threshold, as determined by DNA sequence comparitor 212 at block 408, the match is rejected, at block 410, and process 400 flow continues at block 418.

If the normalized score is within the confidence threshold, as determined by DNA sequence comparitor 212 at block 408, process 400 flow continues at block 412.

At decision block 412, patient profile manager 216 checks the patient names associated with the normalized scores. If the patient names associated with the normalized scores matches the name associated with the biological sample, as determined at block 412, the match is flagged as consistent with the origin identity of the biological sample at block 416. Process 400 continues at decision block 418

Conversely, if the patient names associated with the normalized scores does not match the name associated with the biological sample, as determined at block 412, the match is flagged as for a quality control check at block 414. Process 400 continues at decision block 418.

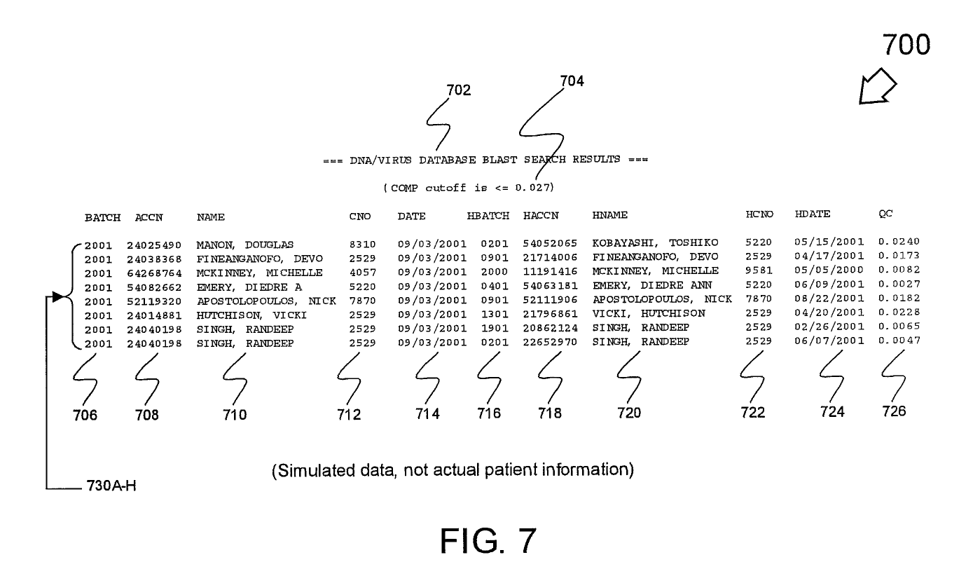

An example output 700 with normalized score matches are shown in FIG. 7, constructed and operative in accordance with an embodiment of the present invention. It is understood that the output 700 is for illustrative purposes only, and that other embodiments may differ in their organization of information. As shown, output 700 may comprise a title 702 and confidence threshold information 704 and sample matching data 730A-H. Furthermore, the sample matching data may be organized in multiple columns, including batch identifier 706, sample account number 708, sample patient name 710, patient (customer) identifier 712, sample date 714, matching batch identifier 716, matching sample account number 718, matching patient name 720, matching patient identifier 722, matching sample date 714, and the normalized score of the match 726.

The task of determining whether the patient names match the normalized score sample names at block 412 can be further clarified with reference to the matching data examples 730A-H.

It is clear that matching data 730A is an example of a mismatched patient names because the sample patient name 710 “Manon, Douglas” is not the same as the matching patient name 720 “Kobayashi, Toshiko.” This sample output would be flagged for a quality control check at block 414.

Matching data 730B-C, 730E, 730G-H are examples where the sample patient name 710 exactly matches the matching patient name 720. These sample outputs would be flagged as consistent with the identity of the sample origin at block 416.

Matching data 730D is an example where the sample patient name 710 does not exactly match the matching patient name 720 because of a difference in the middle name of the patient. Various embodiments may treat example case 730D differently, depending upon the sensitivity of the matching algorithm used at block 412. In some embodiments, the presence of a middle name may be ignored or matched only to the first initial, and flow would continue at block 416. In yet other embodiments, any inconsistency of the middle name would be flagged for a quality control double check at block 414.

Matching data 730F is an example where the sample patient name 710 does not exactly match the matching patient name 720 because of a reversal of a first and last name. This is an example of a problem, most likely a laboratory labeling or data input error. This type of error would, in most embodiments, be flagged for a quality control double check at block 414, to allow the names to be corrected.

In some embodiments, the flagging for consistency or quality control check may simply be an output 700 indicating the sample patient name 710 and the matching patient name 720.

It is understood that in some embodiments, patient names may be replaced with other patient identifiers, such as social security numbers, or other identifier, as is known in the art. Such embodiments may be used in situations where patient names are unknown, or are held confidentially.

Returning to FIG. 4, at decision block 418, test sample tracker 214 determines whether each normalized score of the closest matches has been checked. If not, the next normalized score is examined, and flow returns to block 408. If each of the closest matches has been checked, as determined at decision block 418, the results are reported at block 420, and process 400 ends.

In some embodiments, process 400 adds all the patient sequences to a FASTA file and builds a BLAST-based DNA sequence database 242. Process 400 then searches each patient sequence against the DNA sequence database 242, and reports samples that match other nucleotide sequence in the database with a difference score below a predetermined confidence threshold. The threshold may be calculated for the top five hits according to a normalization formula, giving the relative distance between pairs of samples. In some embodiments, the cutoff may be defined as any score over three standard deviations away from the mean score.

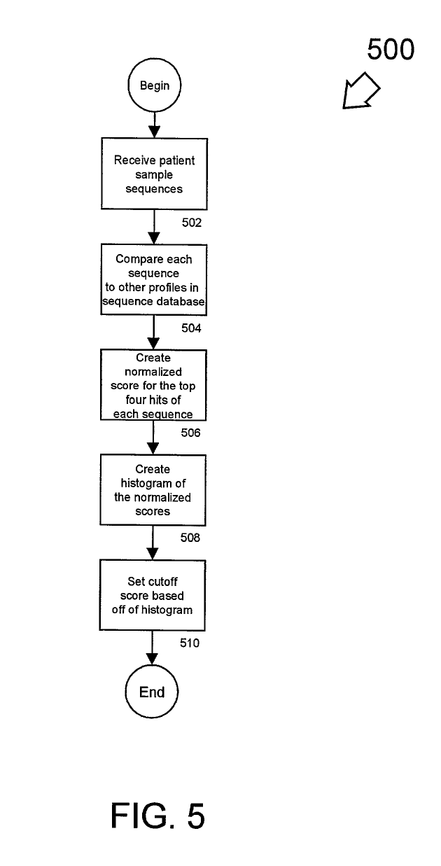

FIG. 5 is a flowchart of process 500 to determine a confidence threshold to assure the quality of a biological sample through genetic or nucleic acid sequence screening, constructed and operative in accordance with an embodiment of the present invention.

The confidence threshold should be restrictive enough to minimize false positives, yet broad enough to insure that patients' sample test results match their own previous test samples. It is understood that the confidence threshold may be adjusted on a case-by-case basis depending upon the type of genomic sequence information being provided, and the test sample pool. Process 500 determines the confidence threshold.

At block 502, process 500 receives patient genomic sequence information. In some embodiments, the patient sequence information may be received from sequencer 109, or previously stored information in DNA sequence database 242. In other embodiments, the patient sequence information may be provided over network 110 by remote computer 120. Regardless, the sequence information may be provided in any format known in the art. Example formats include, but are not limited to, Basic Local Alignment Search Tool (BLAST), FASTA, Stanford/IG, Human Genome Mapping Project (HGMP) and GenBank formats.

Once received, DNA sequence comparitor 212 compares the patient sequence information with other sequences stored in DNA sequence database 242, block 504.

As mentioned above, DNA sequence comparitor 212 may be any structure known in the art capable of comparing sequence information.

An arbitrary number of closest hit scores, as determined by DNA sequence comparitor 212, are normalized, block 506. In some embodiments, the top four hits of each sequence are normalized.

At block 508, process 500 creates a histogram of the normalized scores. Example histogram data is shown below in Table 1.

TABLE 1
Example Histogram Data

| Bin | Frequency | Cumulative % |
|---|---|---|
| 0.00% | 0 | .00% |
| 1.00% | 8 | .55% |
| 2.00% | 3 | .75% |
| 3.00% | 2 | .89% |
| 4.00% | 1 | .96% |
| 5.00% | 2 | 1.09% |
| 6.00% | 2 | 1.23% |
| 7.00% | 4 | 1.50% |
| 8.00% | 8 | 2.05% |
| 9.00% | 11 | 2.80% |
| 10.00% | 12 | 3.62% |
| 11.00% | 33 | 5.87% |
| 12.00% | 73 | 10.86% |
| 13.00% | 91 | 17.08% |
| 14.00% | 118 | 25.14% |
| 15.00% | 114 | 32.92% |
| 16.00% | 124 | 41.39% |
| 17.00% | 153 | 51.84% |
| 18.00% | 133 | 60.93% |
| 19.00% | 127 | 69.60% |
| 20.00% | 106 | 76.84% |
| 21.00% | 91 | 83.06% |
| 22.00% | 70 | 87.84% |
| 23.00% | 51 | 91.33% |
| 24.00% | 34 | 93.65% |
| 25.00% | 32 | 95.83% |
| 26.00% | 16 | 96.93% |
| 27.00% | 14 | 97.88% |
| 28.00% | 11 | 98.63% |
| 29.00% | 4 | 98.91% |
| 30.00% | 3 | 99.11% |
| 31.00% | 1 | 99.18% |
| 32.00% | 0 | 99.18% |
| 33.00% | 0 | 99.18% |
| 34.00% | 1 | 99.25% |
| 35.00% | 5 | 99.59% |
| 36.00% | 0 | 99.59% |
| 37.00% | 1 | 99.66% |
| 38.00% | 0 | 99.66% |
| 39.00% | 0 | 99.66% |
| 40.00% | 0 | 99.66% |
| 41.00% | 3 | 99.86% |
| 42.00% | 0 | 99.86% |
| 43.00% | 1 | 99.93% |
| 44.00% | 0 | 99.93% |
| 45.00% | 0 | 99.93% |
| 46.00% | 0 | 99.93% |
| 47.00% | 0 | 99.93% |
| 48.00% | 0 | 99.93% |
| 49.00% | 0 | 99.93% |
| 50.00% | 0 | 99.93% |
| 51.00% | 0 | 99.93% |
| 52.00% | 0 | 99.93% |
| 53.00% | 0 | 99.93% |
| 54.00% | 1 | 100.00% |
| 55.00% | 0 | 100.00% |
| More | 0 | 100.00% |

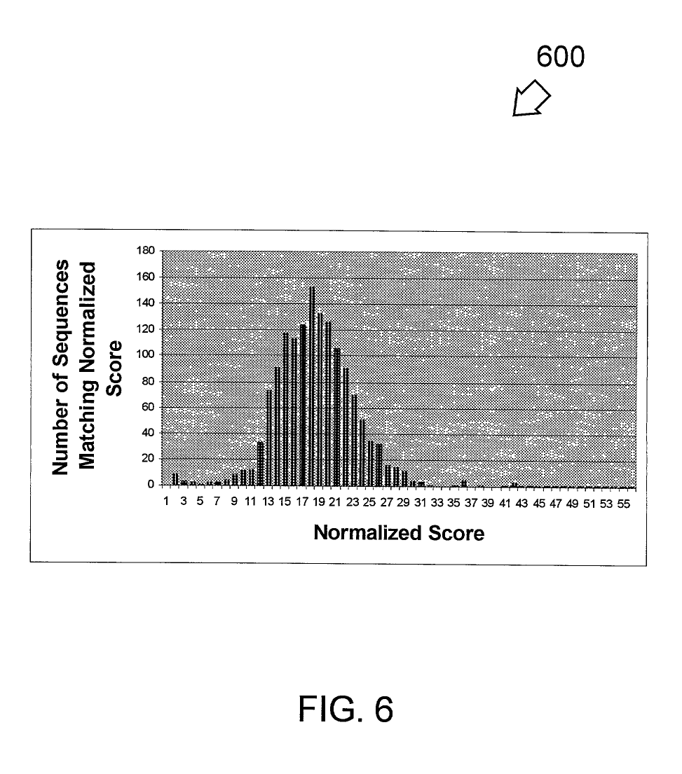

In the above example, the results show normalized scores distributed with a mean of about 17% (0.17). This can also be seen in FIG. 6 as histogram 600 of normalized scores of sequence searches, constructed and operative in accordance with an embodiment of the present invention.

A confidence threshold is set as approximately three standard deviations from the mean score, block 510. It is understood by those known in the art that other confidence thresholds may be equally applicable, depending upon the distribution of average normalized scores. In the above example, three standard deviations from the mean score, is 0.027. As only 13/1464 (0.89%) of the scores are below this number, setting the confidence threshold at 0.027 suggests that the false positive rate will be approximately 1 in 113 match hits. The false positive rate is defined as a match even though the sample samples are from different patients.

The previous description of the embodiments is provided to enable any person skilled in the art to practice the invention. The various modifications to these embodiments will be readily apparent to those skilled in the art, and the generic principles defined herein may be applied to other embodiments without the use of inventive faculty. Thus, the present invention is not intended to be limited to the embodiments shown herein, but is to be accorded the widest scope consistent with the principles and novel features disclosed herein.

What is claimed is:

1. An apparatus comprising:
a sequence database configured to contain entries of sequences;
a sequence comparitor configured to receive a patient sample sequence, to compare the patient sample sequence with entries in the sequence database to determine closest matches, and to normalize a matching score of the closest matches.

2. The apparatus of claim A1, wherein the sequence comparitor is further configured to determine whether the matching score of the closest matches are within a confidence threshold.

3. The apparatus of claim A2 further comprising:
a patient profile manager to reporting whether a sample patient identifier associated with the patient sample sequence matches a matched patient identifier associated with the closest match;

4. The apparatus of claim A3 wherein the patient sample sequence is sequenced from a virus.

5. The apparatus of claim A4 wherein the virus is hepatitis or Human Immunodeficiency Virus (HIV).

6. The apparatus of claim A3 wherein the patient sample sequence is sequenced from deoxyribonucleic acid (DNA).

7. The apparatus of claim A5 wherein the confidence threshold is approximately three standard deviations from an average normalized score.

8. A method comprising:
receiving a patient sample sequence, the patient sample sequence being associated with a sample patient identifier;
comparing the patient sample sequence with entries in a sequence database to determine closest matches, the closest matches being associated with a matched patient identifier;
normalizing a matching score of the closest matches.

9. The method of claim 8 further comprising:
determining whether the matching score of the closest matches are within a confidence threshold.

10. The method of claim 9 further comprising:
reporting the closest matches within the confidence threshold.

11. The method of claim 9 further comprising:
reporting whether the sample patient identifier matches the matched patient identifier;

12. The method of claim 11 wherein the patient sample sequence is sequenced from a virus.

13. The method of claim 12 wherein the virus is hepatitis or Human Immunodeficiency Virus (HIV).

14. The method of claim 10 wherein the patient sample sequence is sequenced from deoxyribonucleic acid (DNA).

15. The method of claim 13 wherein the confidence threshold is approximately three standard deviations from an average normalized score.

16. A computer-readable medium encoded with data and instructions, the data and instructions causing an apparatus executing the instructions to:
receive a patient sample sequence, the patient sample sequence being associated with a sample patient identifier;
compare the patient sample sequence with entries in a sequence database to determine closest matches, the closest matches being associated with a matched patient identifier;
normalize a matching score of the closest matches.

17. The computer-readable medium of claim 16 wherein the instruction further causes an apparatus to:
determine whether the matching score of the closest matches are within a confidence threshold.

18. The computer-readable medium of claim 17 wherein the instruction further causes an apparatus to:
report the closest matches within the confidence threshold.

19. The computer-readable medium of claim 18 wherein the instruction further causes an apparatus to:
report whether the sample patient identifier matches the matched patient identifier;

20. The computer-readable medium of claim 19 wherein the patient sample sequence is sequenced from a virus.

21. The computer-readable medium of claim 20 wherein the virus is hepatitis or Human Immunodeficiency Virus (HIV).

22. The computer-readable medium of claim 18 wherein the patient sample sequence is sequenced from deoxyribonucleic acid (DNA).

23. The computer-readable medium of claim 21 wherein the confidence threshold is approximately three standard deviations from an average normalized score.

24. An apparatus comprising:
means for receiving a patient sample sequence, the patient sample sequence being associated with a sample patient identifier;
means for comparing the patient sample sequence with entries in a sequence database to determine closest matches, the closest matches being associated with a matched patient identifier;
means for normalizing a matching score of the closest matches.

25. The apparatus of claim 24 further comprising:
means for determining whether the matching score of the closest matches are within a confidence threshold.

26. The apparatus of claim 25 further comprising:
means for reporting the closest matches within the confidence threshold.

27. The apparatus of claim 26 further comprising:
means for reporting whether the sample patient identifier matches the matched patient identifier;

28. The apparatus of claim 27 wherein the patient sample sequence is sequenced from a virus.

29. The apparatus of claim 28 wherein the virus is hepatitis or Human Immunodeficiency Virus (HIV).

30. The apparatus of claim 26 wherein the patient sample sequence is sequenced from deoxyribonucleic acid (DNA).

31. The apparatus of claim 29 wherein the confidence threshold is approximately three standard deviations from an average normalized score.
